(19) United States
(12) Patent Application Publication
(10) Pub. No.: US 2006/0139512 A1
(43) Pub. Date: Jun. 29, 2006

(54) Polarizer plate and liquid crystal panel using the same

(75) Inventor: Shuai Guo, Shenzhen (CN)

Correspondence Address: WEI TE CHUNG;FOXCONN INTERNATIONAL, INC., 1650 MEMOREX DRIVE, SANTA CLARA, CA, 95050, US

(73) Assignee: INNOLUX DISPLAY CORP.

(21) Appl. No.: 11/317,857

(22) Filed: Dec. 23, 2005

(30) Foreign Application Priority Data
Dec. 24, 2004 (TW) 93140411

(51) Int. Cl. G02F 1/1335

(52) U.S. Cl. 349/96

(57) ABSTRACT

A polarizer plate (20) includes a surface protection film (21), a protection layer (22), a polarization main body (23), an adhesive layer (24), and a release layer (25) in that order. A second protection layer of a conventional polarizer plate may be omitted. This reduces weight, improves performance, and lowers the cost of materials and manufacture of the polarizer plate. A liquid crystal panel incorporating the polarizer plate is also provided.

### FIELD OF THE INVENTION

The present invention relates to a polarizer plate for a liquid crystal panel.

### GENERAL BACKGROUND

Polarizer plates are widely used in liquid crystal displays, and the demand for polarizer plates has increased rapidly.

As shown in FIG. 6, a typical polarizer plate 10 includes a surface protection film 11, a first protection layer 12, a polarization main body 13, a second protection layer 14, an adhesive layer 15, and a release layer 16, in that order from top to bottom. The surface protection film 11 covers and protects the first protection layer 12 and the polarization main body 13. The first and second protection layers 12, 14 are highly transparent and waterproof, which enable them to support and protect the polarization main body 13. The release layer 16 is used to keep the adhesive layer 15 clean and sticky. In use, the release layer 16 is peeled off, and the polarizer plate 10 is attached to one or more other elements of a liquid crystal panel by the adhesive layer 15.

However, the polarizer plate 10 includes a plurality of films or layers, each of which increases costs. Moreover, a liquid crystal panel using the polarizer plate 10 may need to have an unduly large space in order to contain the polarizer plate 10 having the plurality of films or layers therein.

What is needed, therefore, is a polarizer plate that overcomes the above-described deficiencies.

### SUMMARY

In a preferred embodiment, a polarizer plate includes a surface protection film, a protection layer, a polarization main body, an adhesive layer, and a release layer, disposed in that order from top to bottom.

In use, a liquid crystal panel includes a first substrate, a second substrate, a liquid crystal layer disposed between the substrates, and the polarizer plate arranged at an outer surface of the first substrate. The polarizer plate includes a surface protection film, a protection layer, a polarization main body, an adhesive layer, and a release layer in that order from top to bottom.

The first substrate supports and protects the polarization main body of the polarizer plate, thereby functioning as an equivalent of a second protection layer of a conventional polarizer plate. Thus, the second protection layer of the conventional polarizer plate may be omitted. This reduces weight, improves performance, and lowers the cost of materials and manufacture.

Other advantages and novel features will become more apparent from the following detailed description when taken in conjunction with the accompanying drawings.

### BRIEF DESCRIPTION OF THE DRAWINGS

FIG. 1 is a schematic, partially exploded, isometric view of a polarizer plate according to a first embodiment of the present invention.

FIG. 2 is a schematic, side cross-sectional view of a liquid crystal panel employing the polarizer plate of FIG. 1.

FIG. 3 is a schematic, side cross-sectional view of another liquid crystal panel employing two of the polarizer plates of FIG. 1.

FIG. 4 is a schematic, side cross-sectional view of a polarizer plate according to a second embodiment of the present invention.

FIG. 5 is a schematic, side cross-sectional view of a liquid crystal panel employing the polarizer plate of FIG. 4.

FIG. 6 is a schematic, side cross-sectional view of a conventional polarizer plate.

### DETAILED DESCRIPTION OF PREFERRED EMBODIMENTS

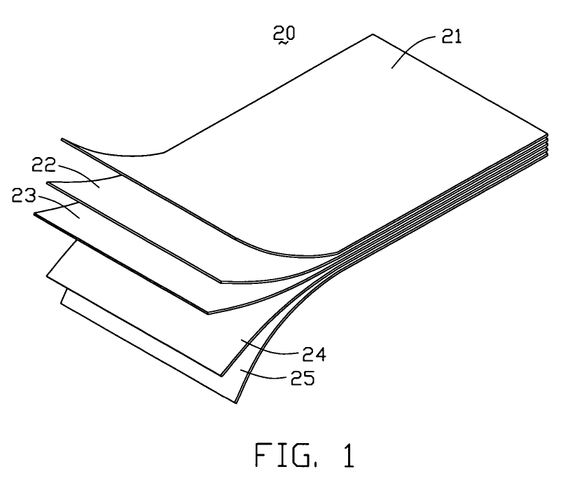

FIG. 1 is a schematic, isometric view of a polarizer plate 20 according to a first embodiment of the present invention. The polarizer plate 20 includes a surface protection film 21, a protection layer 22, a polarization main body 23, an adhesive layer 24, and a release layer 25, in that order from top to bottom. The surface protection film 21 covers and protects the protection layer 22 and the polarization main body 23. The protection layer 22 is highly transparent and waterproof, which enables it to support and protect the polarization main body 23. The release layer 25 is to keep the adhesive layer 24 clean and sticky. In use, the polarizer plate 20 is adhered to one or more other elements of a liquid crystal panel by the adhesive layer 24. The polarization main body 23 is made from polyvinyl alcohol mixed with iodine molecules, or polyvinyl alcohol mixed with iodine molecules and potassium iodide. The protection layer 22 is made from triacetate fiber.

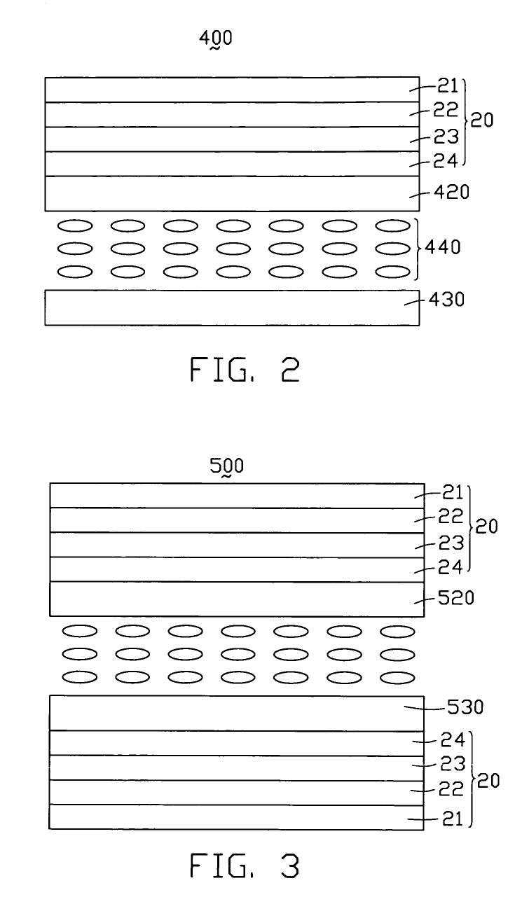

FIG. 2 is a schematic, side cross-sectional view of the polarizer plate 20 employed in a liquid crystal panel 400. The liquid crystal panel 400 includes a first substrate 420, a second substrate 430, and a liquid crystal layer 440 disposed between the substrates 420, 430.

The polarizer plate 20 is arranged on an outer surface of the first substrate 420. The polarizer plate 20 is adhered to the first substrate 420 by the adhesive layer 24. The first substrate 420 provides support and protection for the polarization main body 23, thereby functioning as an equivalent of a second protection layer of a conventional polarizer plate. Thus, a second protection layer of the conventional polarizer plate may be omitted. This reduces weight, improves performance, and lowers the cost of materials and manufacture for the liquid crystal panel 400.

FIG. 3 is a schematic, side cross-sectional view of a liquid crystal panel 500 that employs two of the polarizer plates 20. The liquid crystal panel 500 is similar to the liquid crystal panel 400. However, the liquid crystal panel 500 further includes a second polarizer plate 20 at an outer surface of a second substrate 530. The second polarizer plate 20 is adhered to the second substrate 530 by the adhesive layer 24. A first substrate 520 and the second substrate 530 support and protect the polarization main bodies 23 of the polarizer plates 20. In other embodiments, either of the polarizer plates 20 may instead be another kind of polarizer plate.

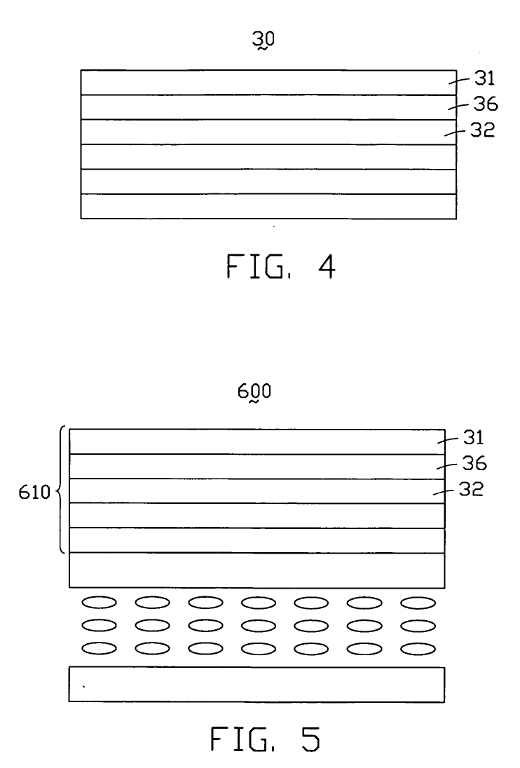

FIG. 4 is a schematic, side cross-sectional view of a polarizer plate 30 according to a second embodiment of the present invention. The polarizer plate 30 is similar to the polarizer plate 20. However, the polarizer plate 30 further includes an anti-reflective layer 36, which is disposed between a surface protection film 31 and a protection layer 32. The anti-reflective layer 36 can reduce the surface reflection rate of the polarizer plate 30 and improve color saturation.

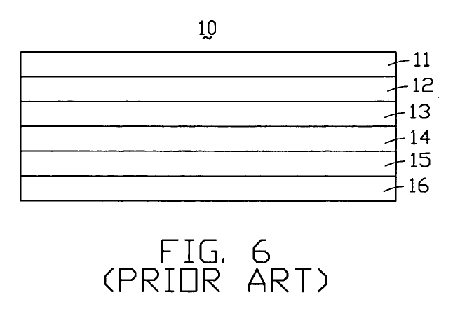

FIG. 5 is a schematic, side cross-sectional view of a liquid crystal panel 600 employing the polarizer plate 30. The liquid crystal panel 600 is similar to the liquid crystal panel 400. However, the liquid crystal panel 600 further includes the anti-reflective layer 36 that is disposed between the surface protection film 31 and the protection layer 32 of the polarizer plate 30. The anti-reflective layer 36 reduces the surface reflection rate and improves the color saturation of the liquid crystal panel 600.

It is to be understood, however, that even though numerous characteristics and advantages of the present embodiments have been set out in the foregoing description, together with details of the structures and functions of the embodiments, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A polarizer plate, comprising in order:
a surface protection film;
a protection layer;
a polarization main body;
an adhesive layer; and
a release layer.

2. The polarizer plate as claimed in claim 1, wherein the polarization main body is made from polyvinyl alcohol mixed with iodine molecules.

3. The polarizer plate as claimed in claim 1, wherein the polarization main body is made from polyvinyl alcohol mixed with iodine molecules and potassium iodide.

4. The polarizer plate as claimed in claim 1, wherein the protection layer is made from triacetate fiber.

5. The polarizer plate as claimed in claim 1, further comprising an anti-reflective layer disposed between the surface protection film and the protection layer.

6. A liquid crystal panel, comprising:
a first substrate;
a second substrate;
a liquid crystal layer disposed between the substrates; and
a first polarizer plate arranged at an outer surface of the first substrate, the first polarizer plate comprising a surface protection film, a protection layer, a polarization main body, and an adhesive layer in that order.

7. The liquid crystal panel as claimed in claim 6, further comprising an anti-reflective layer between the surface protection film and the protection layer.

8. The liquid crystal panel as claimed in claim 6, further comprising a second polarizer plate disposed at an outer surface of the second substrate.

9. The liquid crystal panel as claimed in claim 8, wherein the second polarizer plate has a same structure as that of the first polarizer plate.
